(19) United States
(12) Patent Application Publication
(10) Pub. No.: US 2016/0109787 A1
(43) Pub. Date: Apr. 21, 2016

(54) IMAGING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHIN-WEN YEH, New Taipei (TW); DUN-JUN ZHOU, Wuhan (CN)

(21) Appl. No.: 14/530,046

(22) Filed: Oct. 31, 2014

(30) Foreign Application Priority Data
Oct. 17, 2014 (CN) 201410551377.6

(51) Int. Cl. G03B 21/14; G03B 21/16

(52) U.S. Cl. CPC G03B 21/145; G03B 21/16

(57) ABSTRACT

An imaging device includes an imaging module and a control module. The imaging module receives an imaging assembly which is capable of creating images. The control module receives a control assembly capable of controlling the imaging assembly and a power supply capable of supplying power to the control assembly and the imaging assembly. The imaging module is electronically coupled to the control module. The imaging module is removably mounted to the control module.

### FIELD

The subject matter herein generally relates to an imaging device.

### BACKGROUND

An imaging device, such as a projector, generally includes an imaging module, a control module configured to control the imaging module, and a power supply configured to supply power to the imaging module and the control module. The imaging module, the power supply, and the control module are located in a housing of the imaging device.

### BRIEF DESCRIPTION OF THE DRAWINGS

Implementations of the present technology will now be described, by way of example only, with reference to the attached figures.

FIG. 1 is an exploded, isometric view of an embodiment of an imaging device.

FIG. 2 is similar to FIG. 1, but viewed from a different angle.

FIG. 3 is a partially exploded, isometric view of an embodiment of an imaging module and a control module of the imaging device of FIG. 1.

FIG. 4 is similar to FIG. 3, but viewed from a different angle.

FIG. 5 is an assembled, isometric view of the imaging device of FIG. 1.

FIG. 6 is similar to FIG. 5, but showing a part of a first case separated from the imaging module of the imaging device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

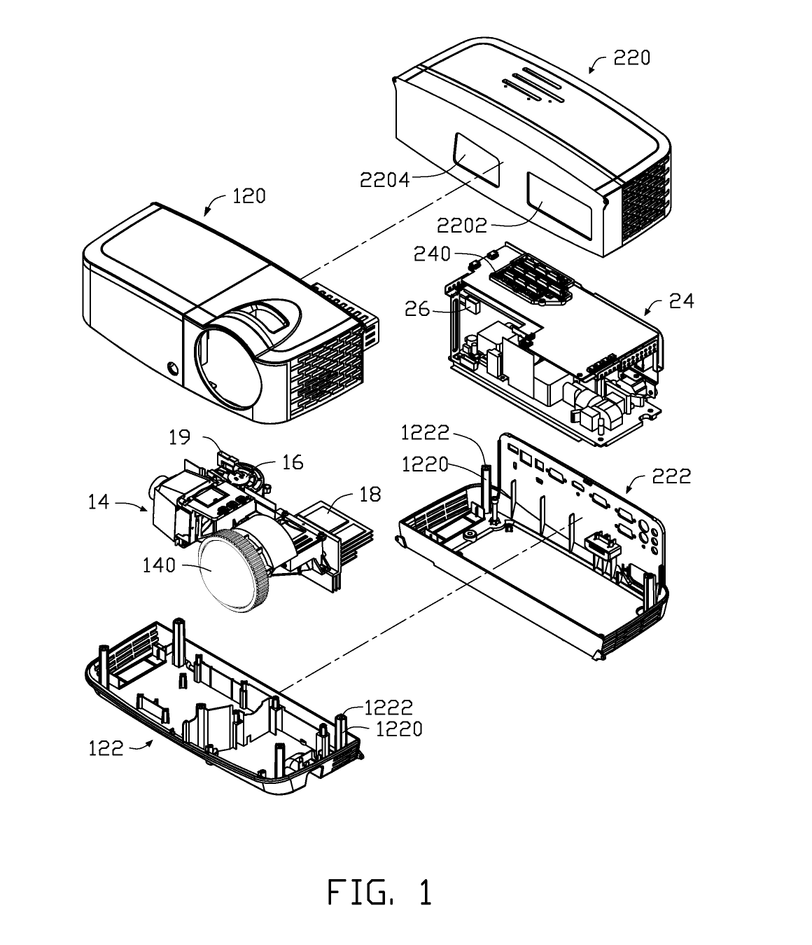

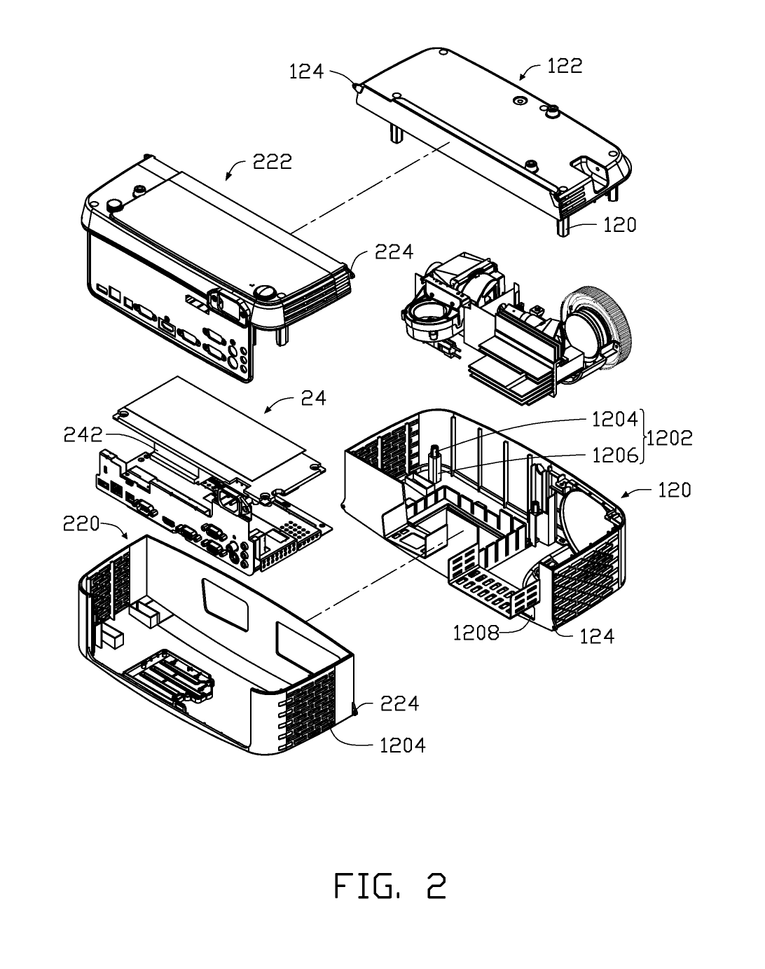

FIGS. 1 and 2 illustrate an imaging device in accordance with an embodiment. The imaging device 100 can include an imaging module 10 and a control module 20. In at least one embodiment, the imaging device 100 is a projector.

The imaging module 10 can include a case 12, an imaging assembly 14, a fan 16, a plurality of cooling fins 18, and a socket 19. The case 12 can include a first top cover 120, a first bottom cover 122, and two first mounting portions 124 extending outwards from each of the first bottom cover 122 and the first top cover 120. Each mounting portion 124 defines a through hole (not labeled). The first top cover 120 can include at least one mounting post 1202 and defines a receiving slot 1208. The mounting post 1202 can include a post body 1206 and an engaging portion 1204 extending upwards from a top surface of the post body 1206. A cross sectional area of the engaging portion 1204 is smaller than a cross sectional area of the post body 1206.

The first bottom cover 122 can include a receiving portion 1220 with a receiving hole 1222. In at least one embodiment, the receiving portion 1220 is hollow podetium. The imaging assembly 14 is configured to create images and can include a lens 140 configured to project the images.

The control module 20 can include a chassis 22, a power supply 242, a control assembly 24, and a plug 26. The chassis 22 is substantially rectangular and can include a second top cover 220, a second bottom cover 222, and two second mounting portions 224 extending outwards from each of the second bottom cover 222 and the second top cover 220. Each mounting portion 224 defines a through hole (not labeled). The second top cover 220 can include at least one mounting post 1202 and defines a first opening 2202 and a second opening 2204. The first opening 2202 and the second opening 2204 are defined in a front wall of the second top cover 220. The second bottom cover 222 further includes a receiving portion 1220.

The control assembly 24 includes a plurality of control components 240 configured to control the imaging assembly 14 to create images. The power supply 242 is configured to supply power to the control assembly 24 and the imaging assembly 14. In at least one embodiment, the imaging assembly 14 can be a light machine of a projector or a camera assembly.

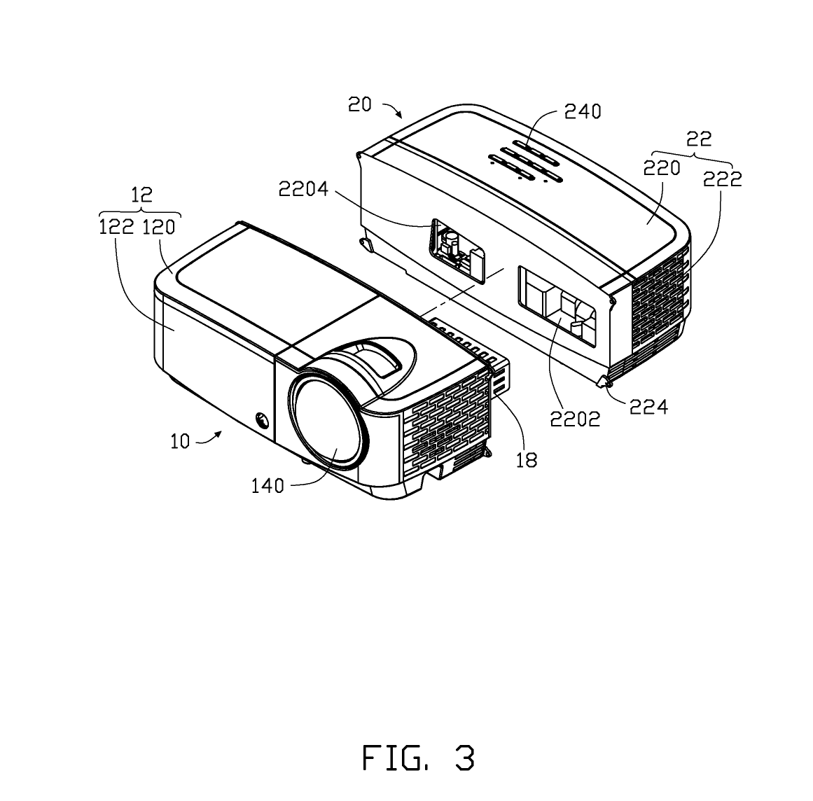

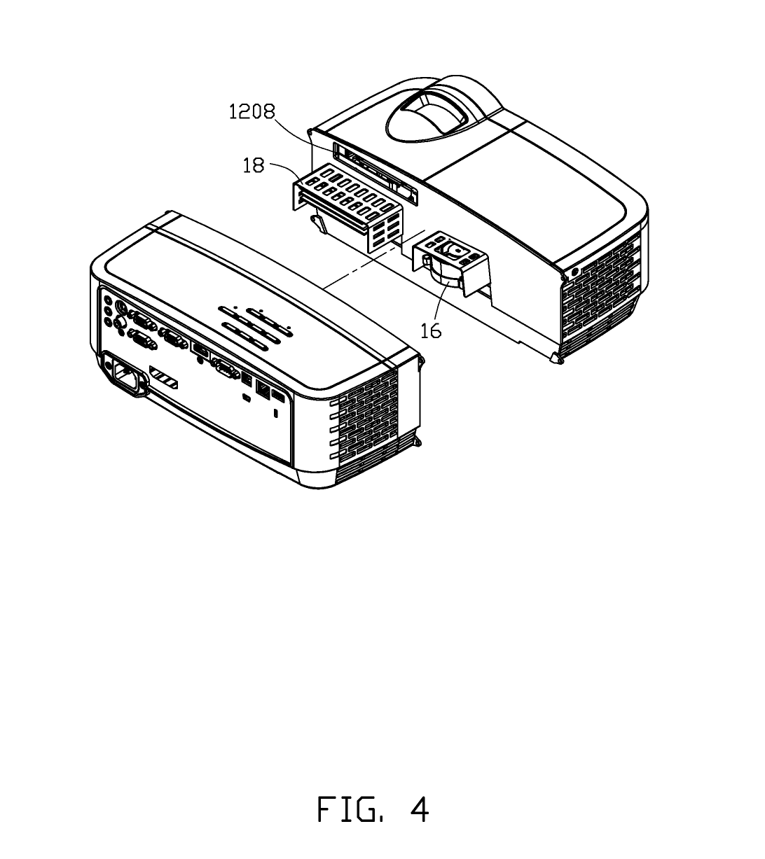

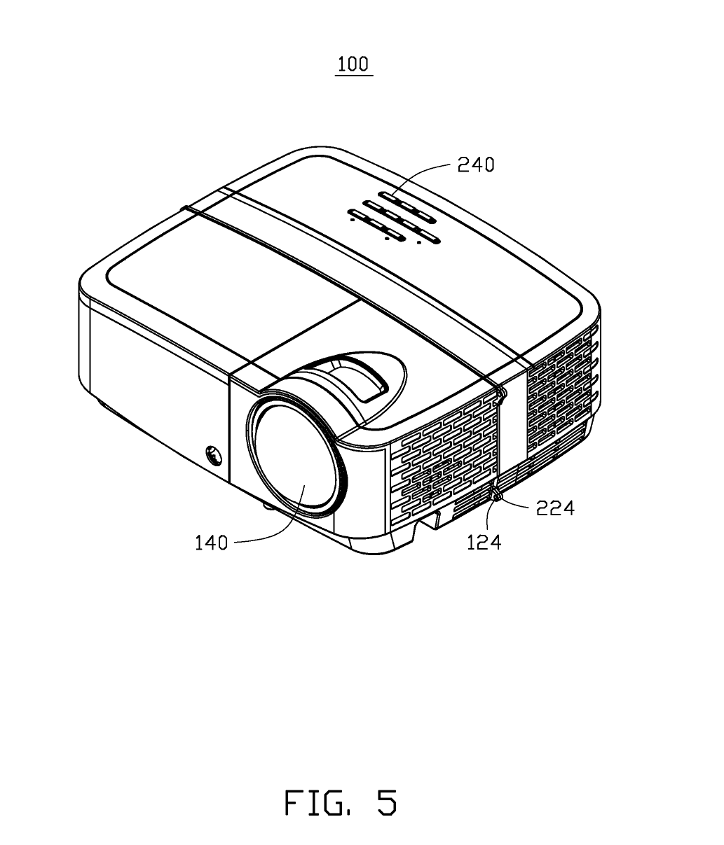

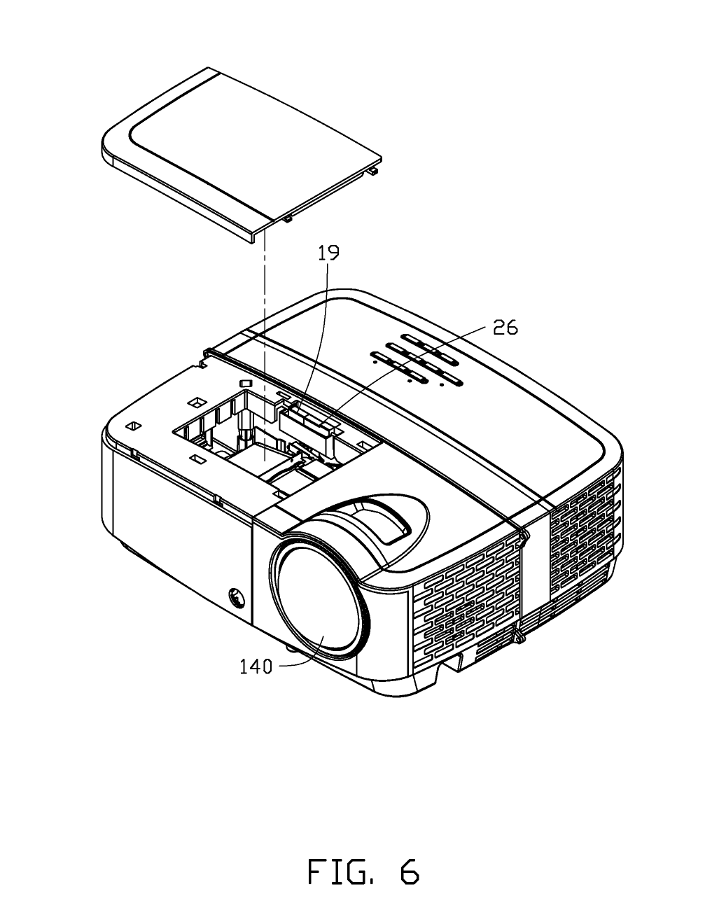

Referring to FIGS. 3-6, in assembly, the imaging assembly 14, the fan 16, the cooling fins 18, and the socket 19 are mounted in the first bottom cover 122. The engaging portion 1204 is engaged in the receiving hole 1222, and the post body 1206 abuts the receiving portion 1220. Thus the first top cover 120 is attached to the first bottom cover 122 to cover the imaging assembly 14, the fan 16, the cooling fins 18, and the socket 19, and the imaging module 10 is completely assembled. The fan 16 the cooling fins 18 are located in a first side of the case 12, and the lens 140 is located in a second side of the case 12.

The control assembly 24 and the plug 26 are received in the second bottom cover 222. The mounting post 1202 of the second top cover 220 is engaged in the receiving portion 1220 of the second bottom cove 222. The second top cover 220 is attached to the second bottom cover 222 to cover the control assembly 24 and the plug 26. Thus the control module 20 is completely assembled.

The plug 26 is coupled to the socket 19 via the first opening 2202 and the receiving slot 1208, enabling the imaging module 10 to be electronically coupled to the control module 20. The fan 16 is partially received in the second opening 2204, and the cooling fins 18 is partially received in the first opening 2202, to cool the imaging device 100. A fastener (not shown) extends into the first mounting portion 124 and the second mounting portion 224 to secure the imaging module 10 to the control module 20.

The embodiments shown and described above are only examples. Many details are often found in the art such as the other features of an imaging device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An imaging device comprising:
an imaging module receiving an imaging assembly which is capable of creating images; and
a control module receiving:
a control assembly capable of controlling the imaging assembly, and
a power supply capable of supplying power to the control assembly and the imaging assembly;
wherein the imaging module is electronically coupled to the control module, and the imaging module is removably mounted to the control module.

2. The imaging device of claim 1, wherein the imaging module comprises a case, and the imaging module is received in the case; the control module comprises a chassis, and the control assembly is received in the chassis; and the case is removably mounted to the chassis.

3. The imaging device of claim 2, wherein the imaging module further comprises a plurality of cooling fins, the case defines a first opening, and each cooling fin extends out of the case through the first opening.

4. The imaging device of claim 3, wherein the imaging assembly is received in the case, the imaging assembly is located in a first side of the case, and the cooling fins are located in a second side of the case.

5. The imaging device of claim 4, wherein the imaging module further comprises a fan, the case further defines a second opening, and the fan extends out of the case through the second opening.

6. The imaging device of claim 5, wherein the fan is located in the first second side of the case.

7. The imaging device of claim 1, wherein the imaging module further comprises a first mounting portion, the control module further comprises a second mounting portion, a fastener extends into the first mounting portion and the second mounting portion.

8. The imaging device of claim 2, wherein the case comprises a first top cover and a first bottom cover, the imaging assembly is mounted in the first bottom cover, and the first top cover is secured to the first bottom cover and covers the imaging assembly.

9. The imaging device of claim 8, wherein the first top cover comprises a mounting post, the first bottom cover comprises a receiving portion, and the mounting post is engaged with the receiving portion to secure the first top cover to the first bottom cover.

10. The imaging device of claim 9, wherein the mounting post comprises a post body and an engaging portion extending from the post body, the receiving portion defines a receiving hole, the engaging portion is engaged in the receiving hole, and the post body abuts a top edge of the receiving portion.

11. An imaging device comprising:
an imaging module comprising a case and an imaging assembly received therein, the imaging assembly being capable of creating images; and
a control module comprises a chassis receiving:
a control assembly capable of controlling the imaging assembly, and
a power supply capable of supplying power to the control assembly and the imaging assembly;
wherein the imaging module is electronically coupled to the control module, and the case is removably attached to the chassis, enabling the imaging module to be removable relative to the control module.

12. The imaging device of claim 11, wherein the imaging module further comprises a plurality of cooling fins, the case defines a first opening, and each cooling fin extends out of the case through the first opening.

13. The imaging device of claim 12, wherein the imaging assembly is located in a first side of the case, and the cooling fins are located in a second side of the case.

14. The imaging device of claim 13, wherein the imaging module further comprises a fan, the case further defines a second opening, and the fan extends out of the case through the second opening.

15. The imaging device of claim 14, wherein the fan is located in the first second side of the case.

16. The imaging device of claim 11, wherein the case comprises a first mounting portion, the chassis comprises a second mounting portion, a fastener extends into the first mounting portion and the second mounting portion to secure the case to the chassis.

17. The imaging device of claim 11, wherein the case comprises a first top cover and a first bottom cover, the imaging assembly is mounted in the first bottom cover, and the first top cover is secured to the first bottom cover and covers the imaging assembly.

18. The imaging device of claim 17, wherein the first top cover comprises a mounting post, the first bottom cover comprises a receiving portion, and the mounting post is engaged with the receiving portion to secure the first top cover to the first bottom cover.

19. The imaging device of claim 18, wherein the mounting post comprises a post body and an engaging portion extending from the post body, the receiving portion defines a receiving hole, and the engaging portion is engaged in the receiving hole.

20. The imaging device of claim 19, wherein the post body abuts a top edge of the receiving portion.
